(19) United States
(12) Patent Application Publication
(10) Pub. No.: US 2025/0201460 A1
(43) Pub. Date: Jun. 19, 2025

(54) FIELD MAGNET UNIT FOR POWER CONVERSION DEVICE

(71) Applicants: Hyung Ju YOO, Seoul (KR); Woo Hee CHOI, Seoul (KR); Nan Kyung HWANG, Seoul (KR)

(72) Inventors: Hyung Ju YOO, Seoul (KR); Woo Hee CHOI, Seoul (KR); Nan Kyung HWANG, Seoul (KR); Sung Kwon YU, Seoul (KR)

(21) Appl. No.: 18/870,823

(22) PCT Filed: Apr. 26, 2023
(86) PCT No.: PCT/KR2023/005652

§ 371 Date: Dec. 2, 2024

(30) Foreign Application Priority Data
Apr. 26, 2022 (KR) 10-2022-0051661
Apr. 26, 2022 (KR) 10-2022-0051669
Apr. 26, 2022 (KR) 10-2022-0051671
Apr. 26, 2022 (KR) 10-2022-0051673
Apr. 25, 2023 (KR) 10-2023-0054377
Apr. 25, 2023 (KR) 10-2023-0054378
Apr. 25, 2023 (KR) 10-2023-0054379
Apr. 25, 2023 (KR) 10-2023-0054380

(51) Int. Cl. H01F 7/08; H01F 27/02; H01F 27/30; H01F 27/32

(52) U.S. Cl. CPC H01F 7/081; H01F 27/02; H01F 27/306; H01F 27/324

(57) ABSTRACT

A field unit that can be suitably employed in a power conversion device, includes a cylindrical field unit (1) having a hollow portion (11) in its central portion is provided. The field unit (1) has a housing in which a coil member (40) is accommodated. The housing has a body (10) and a cover (50), and the cover (50) is coupled to the upper side of the body (10). The body (10) and the cover (50) are made of a magnetizable material. The housing is preferably made of SCM (Steel-Cr—No) alloy steel (SCM 456), and is more preferably heat-treated. An annular receiving groove (12) is provided on the upper side of the body (10) centered on the hollow portion (11), and the coil member (40) is press-fitted and installed therein.

### TECHNICAL FIELD

The present invention relates to a field magnet unit that can be suitably employed in a power conversion device.

### BACKGROUND ART

A power conversion device refers to a device that converts direct current into direct current or alternating current of other power, or converts alternating current into alternating current or direct current of other power. A power conversion device is widely used in transmission and distribution facilities including transformers, etc., and power supply devices for various electric and electronic devices. Most power conversion devices are equipped with magnetic devices such as transformers for power conversion. These magnetic devices are composed of, for example, ferrite and have a bobbin on which a coil is wound, and power conversion is performed using the turns ratio between the primary coil and the secondary coil. In some application fields, the primary coil, i.e., the coil that generates a magnetic field, is called a field or field magnet unit, and the secondary coil that generates an induced current corresponding to the magnetic field generated by the field is called an armature or armature unit.

FIG. 1 is a schematic diagram of an example of a power conversion device, which is a configuration example of a power conversion device (100) configured by stacking a field (1:1-1, 1-2) and an armature (2). A power conversion device (100) having such a structure is disclosed in Korean Patent No. 10-2332747 (Title: Non-rotating DC Generator), Patent Publication No. 10-2021-0140835 (Title: Non-rotating AC Generator), Patent Publication No. 10-2021-0141811 (Title: Power Conversion Device), etc.

In the power conversion device (100), the field (1) and the armature (2) are provided with a coil member on which a conductive line is wound. The above power conversion device (100) exists in various forms such as DC-DC, DC-AC, AC-DC, and AC-AC, and the power conversion device (100) is configured in various forms accordingly. In addition, the field (1) is driven in various ways depending on the form of the power conversion device (100). The field (1) is supplied with DC or AC, and the field (1) can be driven alternately as the first field (1-1) and the second field (1-2). The power conversion device (100) may require a greater number of fields (1) depending on the driving method for efficient power conversion, and the structure of the power conversion device (100) becomes complicated accordingly. Usually, the field or electromagnet that generates a magnetic field is configured by winding a conductor around a bobbin. This structure is difficult to properly respond to various structural forms of the power conversion device (100).

In addition, in order to improve the efficiency of the power conversion device (100), it is necessary to increase the intensity of the magnetic field generated from the field (1) and efficiently transmit the generated magnetic field to the armature (2). In the case of a field or electromagnet in which a coil is wound on a bobbin, there is a limit to improving the intensity of the magnetic field due to its structural characteristics. Meanwhile, Korean Patent No. 10-1735860 (title: Electromagnet and electromagnetic coil assembly) discloses an electromagnet configured in a flat plate shape. The electromagnet or electromagnetic coil assembly disclosed herein is configured by forming an annular groove in a pole piece composed of a magnetizable material, mounting a coil assembly therein, and installing an armature plate on the upper side thereof. This invention generates a coupling force between the pole piece and the armature by the flow of magnetic flux passing through the pole piece and the armature, and this has limitations in the scope of its use, such as in a clutch assembly for power transmission. In addition, this invention has disadvantages such as magnetic flux loss occurring due to clearance between the coil assembly and the pole piece.

### DETAILED DESCRIPTION OF THE INVENTION

### Technical Problem

The present invention has a technical purpose to provide a field magnet unit for a power conversion device that can be made lightweight and compact and can be applied and used appropriately to various structural forms of a power conversion device.

In addition, the present invention has another technical purpose to provide a field magnet unit that can increase the strength of a magnetic field and improve the efficiency of a power conversion device.

### Technical Solution

According to a first aspect of the present invention for achieving the above object, it is provided to a field magnet unit for a power conversion device configured by stacking a field magnet unit and an armature in a mutually opposing manner, wherein the field magnet unit generates a magnetic field toward the armature according to a current applied from the outside, wherein the field magnet unit comprising:
a cylindrical housing having a hollow portion in the central portion, and
a coil member installed on the inside of the housing, and
wherein the housing comprises a body made of a magnetizable material, having a hollow central portion, and having a receiving groove on the upper portion for mounting the coil member, and a cover installed on the upper portion of the body, having a hollow central portion, and being made of a magnetizable material,
and the coil member comprises first and second terminals for supplying current to the conductive line, and is characterized in that the coil member is configured such that a conductive line is wound around it.

Also, wherein the coil member is installed by being pressed into the receiving groove.

Also, wherein the cover and the body are coupled with an insulating resin.

Also, wherein the housing is composed of SCM alloy steel.

Also, wherein the housing is heat treated.

Also, wherein the lower edge portion of the storage groove has an arc shape.

Also, wherein the outer wall of the storage groove has a thickness of 3 mm or more.

Also, wherein the cover has a thickness of 10 mm or less.

Also, wherein a first cutting groove is provided on the upper surface of the storage groove for withdrawing the first terminal outward.

Also, wherein a drawing hole for drawing a second terminal outward is provided on the lower or outer wall of the storage groove.

Also, wherein a first guide groove is provided on the bottom surface of the storage groove while communicating with the extraction hole.

Also, wherein a second guide groove is provided on the lower surface of the housing and communicates with the extraction hole.

Also, wherein a second cut groove is provided on the upper surface of the storage groove for withdrawing the second terminal outward, and a third guide groove is provided on the lower surface and the outer wall of the storage groove while communicating with the second cut groove.

Also, wherein a fourth guide groove is provided on the inner wall of the storage groove for guiding the second terminal upward, and a fifth guide groove is provided on the lower surface of the cover for guiding the second terminal guided upward by the fourth guide groove toward the outside of the housing.

Also, wherein an insulating film is additionally provided on the upper or lower surface of the housing.

Also, wherein the conductor constituting the coil member has a square or rectangular cross-section.

According to a second aspect of the present invention, a field magnet unit for a power conversion device having a field magnet unit and an armature, which generates a magnetic field, the field magnet unit comprising:
a cylindrical housing having a hollow portion in the central portion, and a coil member installed on the inside of the housing,
wherein the housing includes a body made of a magnetizable material, having a hollow central portion, and having a receiving groove for mounting the coil member on the upper side, and a cover installed on the upper side of the body, having a hollow central portion, and made of a magnetizable material, and
wherein the coil member includes first and second conductors each coated with an insulating material and wound together, and has first and second terminal pairs for supplying field current to the first and second conductors.

Also, wherein the first or second conductor has a square or rectangular cross-section.

According to a third aspect of the present invention, a field magnet unit for a power conversion device having a field magnet unit and an electric field, which generates a magnetic field, the field magnet unit comprising:
a cylindrical housing having a hollow portion in the central portion, and
wherein the housing comprises a body made of a magnetizable material and having a hollow central portion, and a cover installed on the upper side of the body and having a hollow central portion and made of a magnetizable material, and
wherein first and second annular receiving grooves are provided on the upper side of the body centered on the hollow portion,
wherein a first coil member is installed in the first receiving groove, and a second coil member is installed in the second receiving groove, and
wherein the first coil member is provided with a first terminal pair for supplying a field current to the conductor while winding a conductor coated with an insulating material, and
wherein the second coil member is provided with a second terminal pair for supplying a field current to the conductor while winding a conductor coated with an insulating material.

Also, wherein the first or second coil member is installed by being press-fitted into the first or second receiving groove, respectively.

Also, wherein the first and second coil members are driven alternately.

Also, wherein the first and second coil members have conductors wound in opposite directions.

Also, wherein the first and second coil members have the same length of wound conductor.

Also, wherein the housing is composed of SCM alloy steel.

Also, wherein the first and second terminal pairs each have a first terminal coupled to one outer circumference of the first and second coil members and a second terminal coupled to the other inner circumference.

Also, wherein a cutting groove is provided on the upper surface of the second storage groove for withdrawing the first terminal outward.

Also, wherein the first and second extraction holes are provided on the bottom surface of the first receiving groove for extracting the first and second terminals of the first field coil to the outside of the housing, and the third extraction hole is provided on the bottom surface of the second receiving groove for extracting the second terminal of the second field coil to the outside of the housing.

Also, wherein the lower surface of the housing is provided with first to third guide grooves that are respectively connected to the first to third extraction holes.

Also, wherein a fourth guide groove is provided on the inner wall of the first or second storage groove for guiding the second terminal upward, and a fifth guide groove is provided on the lower surface of the cover for guiding the second terminal guided upward by the fourth guide groove toward the outside of the housing.

According to a fourth aspect of the present invention, a field magnet unit for a power conversion device having a field magnet unit and an armature, which generates a magnetic field, and the field magnet unit comprising:
a cylindrical housing having a hollow portion in the central portion, and
wherein the housing comprises a body made of a magnetizable material and having a hollow central portion, and first and second covers installed on the upper and lower sides of the body, respectively, and having hollow central portions and made of a magnetizable material, and
wherein the body has first and second receiving grooves in the upper and lower portions,
wherein first and second coil members are installed in the first and second receiving grooves, respectively, and
wherein the first and second coil members each have a first and second terminal pair for supplying field current to the conductor, and are wound with a conductor coated with an insulating material.

Also, wherein the first and second coil members are driven alternately.

Also, wherein the first and second coil members have conductors wound in opposite directions.

Also, wherein the housing is composed of SCM alloy steel.

Also, wherein the first and second terminal pairs each have a first terminal coupled to one outer circumference of the first and second coil members and a second terminal coupled to the other inner circumference of the coil member.

Also, wherein a first cutting groove is provided on the upper surface of the first or second storage groove for withdrawing the first terminal outward.

Also, wherein an extraction hole is provided on the outer wall of the first or second storage groove for withdrawing the second terminal to the outside, and a first guide groove is provided on the bottom surface of the first or second storage groove while communicating with the extraction hole.

### Advantageous Effects

According to the present invention having the above-described configuration, a cylindrical field magnet unit having a hollow portion in the center is provided. The housing of the field magnet unit has a body and a cover, and the cover is connected to the upper side of the body. A receiving groove is provided on the upper side of the body, and a coil member is press-fitted and installed therein. Accordingly, the clearance between the body and the coil member is minimized, and the loss of magnetic flux generated by the coil member is minimized. The field magnet unit of the present invention can reduce the thickness of the housing overall by increasing the width of the receiving groove, so it is advantageous for lightness and compactness. In addition, according to the present invention, a plurality of coil members are provided in one field magnet unit, and these coil members can be driven or connected in various ways. Therefore, the field magnet unit according to the present invention can be applied appropriately to various usage environments of power conversion devices.

### BRIEF DESCRIPTION OF DRAWINGS

The attached drawings are for explaining embodiments according to the present invention. Therefore, it should be understood that some components may be exaggerated or omitted for efficient explanation of the embodiments. Additionally, in the attached drawings, substantially identical components are given identical reference numbers throughout.

FIG. 1 is a schematic diagram showing an example of a power conversion device (100) having a field (1:1-1, 1-2) and an armature (2).

FIG. 2 is a perspective view of a field magnet unit (1) according to a first embodiment of the present invention as viewed from above.

FIG. 3 is a perspective view of a field magnet unit (1) shown in FIG. 2 as viewed from below.

FIG. 4 is an exploded perspective view of a field magnet unit (1) shown in FIG. 2.

FIG. 5 is a plan view and a back view of a body (10) in FIG. 4 and a cross-sectional view along line A-A′.

FIG. 6 is a cross-sectional view of a main part for explaining a manufacturing method of a field magnet unit (1) according to the present invention.

FIG. 7 is a cross-sectional view showing a structure of a body (60) according to a modified example of the present invention.

FIG. 8 is a perspective view showing a structure of a body (80) according to a first modified example of the first embodiment of the present invention. FIG. 9 is a perspective view showing the structure of a body (90) according to a second modified example of the first embodiment.

FIG. 10 is a perspective view showing the structure of a housing (110, 120) according to a third modified example of the first embodiment.

FIG. 11 is a perspective view of a field magnet unit (1) according to a second embodiment of the present invention as viewed from above.

FIG. 12 is a perspective view of a field magnet unit (1) shown in FIG. 11 as viewed from below.

FIG. 13 is an exploded perspective view of a field magnet unit (1) shown in FIG. 11.

FIG. 14 is a perspective view showing the external shape of a coil member (140) in FIG. 13.

FIG. 15 is a perspective view of a field magnet unit (1) according to a third modified example of the present invention as viewed from above.

FIG. 16 is a perspective view of a field magnet unit (1) shown in FIG. 15 as viewed from below.

FIG. 17 is an exploded perspective view of the field magnet unit (1) shown in FIG. 15.

FIG. 18 is a plan view and a back view of the body (210) in FIG. 17 and a cross-sectional view along line B-B′.

FIG. 19 is a perspective view showing the structure of a housing (210A, 50A) according to another modified example of the third embodiment.

FIG. 20 is a perspective view of the field magnet unit (1) according to the fourth embodiment of the present invention as viewed from above.

FIG. 21 is an exploded perspective view of the field magnet unit (1) shown in FIG. 20.

FIG. 22 is a perspective view of the body (310) in FIG. 21 as viewed from below.

FIG. 23 is a plan view and a back view of the body (310) in FIG. 21 and a cross-sectional view along line C-C′.

### DETAILED DESCRIPTION OF THE INVENTION

In the present invention, a cylindrical field magnet unit having a hollow portion in the center is provided. The field magnet unit has a housing in which a coil member is accommodated. The housing has a body and a cover, and the cover is coupled to the upper side of the body. The body and the cover are composed of a magnetizable material. The housing is preferably composed of SCM (Steel-Cr—No) alloy steel (SCM 456), and is more preferably heat-treated. An annular receiving groove is provided on the upper side of the body centered on the hollow portion, and a coil member is press-fitted and installed therein. The coil member is composed of a conductor coated with an insulating material wound around it, and the coil member is provided with first and second terminals for supplying field current from the outside. These first and second terminals are extended to the outside of the housing.

Hereinafter, embodiments according to the present invention will be described with reference to the drawings. However, the embodiments described below are illustrative of one preferred implementation example of the present invention, and the examples of these embodiments are not intended to limit the scope of the rights of the present invention. Those skilled in the art will readily understand that the present invention can be implemented by making various modifications within a scope that does not depart from the technical idea thereof.

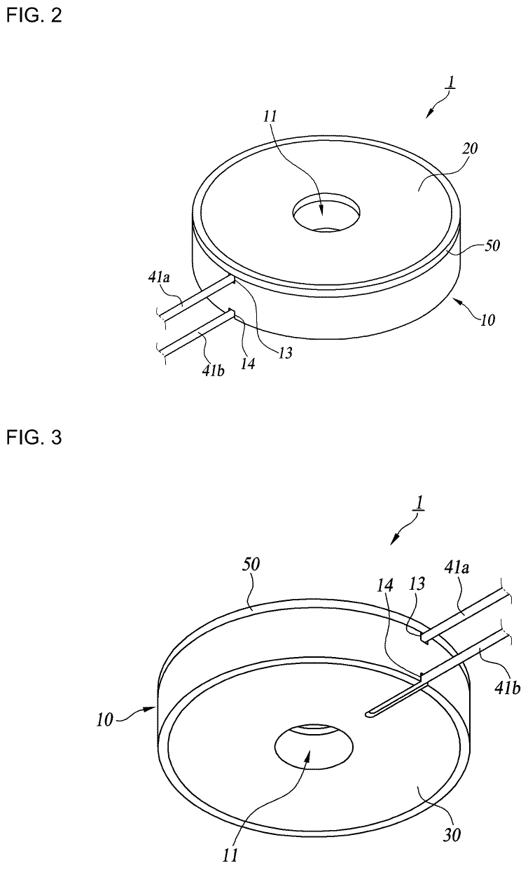

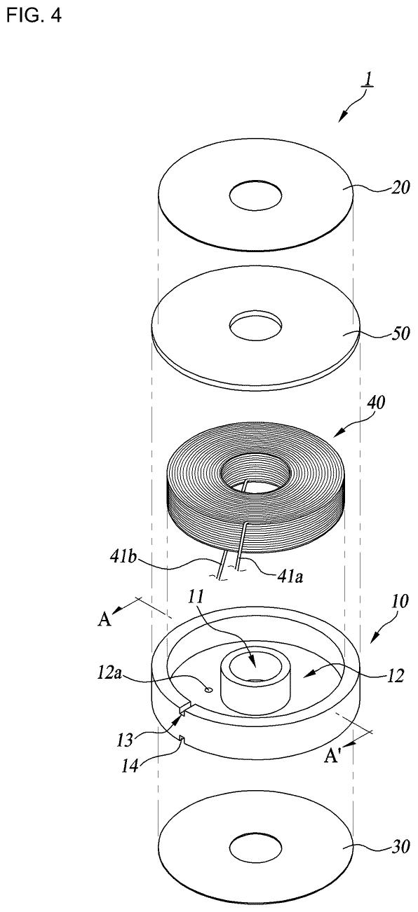

FIGS. 2 and 3 are perspective views of a field magnet unit (1) according to a first embodiment of the present invention, wherein FIG. 2 is a perspective view of the field magnet unit (1) viewed from above, and FIG. 3 is a perspective view of the field magnet unit (1) viewed from below. In addition, FIG. 4 is an exploded perspective view of the field magnet unit (1) shown in FIGS. 2 and 3. In the drawings, the field magnet unit (1) has a housing including a body (10) and a cover (50), and a coil member (40) is mounted inside the housing (10, 50). The coil member (40) is configured to have a structure in which a conductor coated with an insulating material such as enamel is wound, as is the case with conventional ones. The coil member (40) is provided with first and second terminals (41a, 41b) for supplying current, and these are drawn out to the outside of the housing (10, 50). The structure of the coil member (40) and the drawing structure of the first and second terminals (41a, 41b) will be described in more detail later.

In FIGS. 2 to 4, the housing, i.e., the body (10) and the cover (50), are made of a magnetizable material, such as iron. In a preferred embodiment, SCM (Steel-Cr—No) alloy steel (SCM 456) is used as the material of the housing (10, 50), and in a more preferred embodiment, the housing (10, 50) is formed by heat-treating SCM 456 containing 45% carbon at, for example, 800° C. for 4 hours.

The housing (10, 50) is formed in a cylindrical shape with a hollow portion (11) provided in the central portion. Although not specifically shown in the drawing, a cylindrical core member is inserted into the hollow portion (11) as needed. The diameter and height of the housing (10, 50), i.e., the size of the housing (10, 50), are not specified. The size of the housing (10, 50) may be appropriately changed depending on the usage environment. For example, when manufacturing a field magnet unit that generates the same magnetic flux density, if the diameter of the housing is increased, the height of the housing can be correspondingly reduced.

The body (10) is configured as a cylindrical shape with a hollow central portion. An annular receiving groove (12) is provided on the upper surface of the body (10) centered on the hollow portion (11), and a coil member (40) is installed in the receiving groove (12). The size of the receiving groove (12) is set to an appropriate size considering the size of the coil member (40). In a preferred embodiment of the present invention, the coil member (40) is press-fitted into the receiving groove (12). This is to minimize the loss of magnetic flux generated in the coil member (40) by closely contacting the body (10) and the coil member (40). In addition, in order to provide appropriate coercive force for the magnetic flux generated in the coil member (40), the thickness of the outer wall of the receiving groove (12) is set to, for example, 3 mm or more. The cover (50) is configured as a circular plate shape with a hollow central portion. The thickness of the cover (50) is set to, for example, 10 mm or less for smooth magnetic flux projection in the up-down direction. In addition, an insulating film (20, 30) such as Teflon is attached to the upper and lower surfaces of the housing (10, 50) as needed.

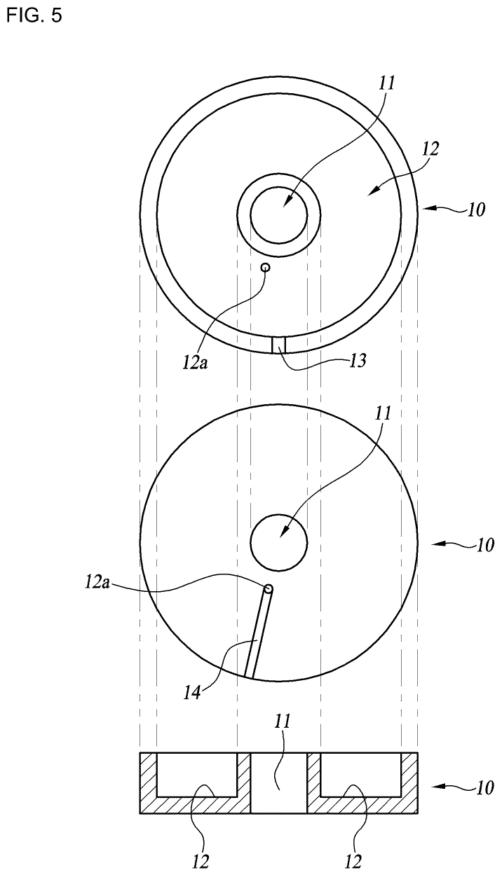

FIG. 5 is a plan view and a back view of the body (10) constituting the housing in FIG. 4, and a cross-sectional view along the line A-A′. As described above, the coil member (40) is provided with first and second terminals (41a, 41b). When forming a coil member (40), the conductor is wound in a circular shape, and due to the manufacturing characteristics, the first terminal (41a) and the second terminal (41b) are arranged in opposite positions. For example, the first terminal (41a) is drawn out from the upper outer periphery of the coil member (40), and the second terminal (41b) is drawn out from the lower inner periphery of the coil member (40). Hereinafter, the first terminal (41a) will be referred to as the outer terminal, and the second terminal (41b) will be referred to as the inner terminal. Of course, the points at which the outer terminal (41a) and the inner terminal (41b) are drawn out from the coil member (40) can be appropriately set. The drawing points of the outer terminal (41a) and the inner terminal (41b) are appropriately set in consideration of the convenience of wiring the field magnet unit (1).

In FIGS. 4 and 5, a cut groove (13) is formed on the upper surface of the body (10), more specifically, on the upper surface of the outer wall forming the receiving groove (12), so as to communicate with the outer surface of the body (10) and the receiving groove (12). This cut groove (13) is for withdrawing the outer terminal (41a) of the coil member (40) to the outside of the housing. In addition, a withdrawal hole (12a) is formed on the lower portion of the receiving groove (12) so as to withdraw the inner terminal (41b) of the coil member (40) to the outside, and a guide groove (14) is formed on the lower surface of the body (10) so as to communicate with the withdrawal hole (12a) and toward the circumferential surface. This guide groove (14) is designed to allow the housing (10, 50) to be placed in close contact with other devices, etc., and may be omitted as needed.

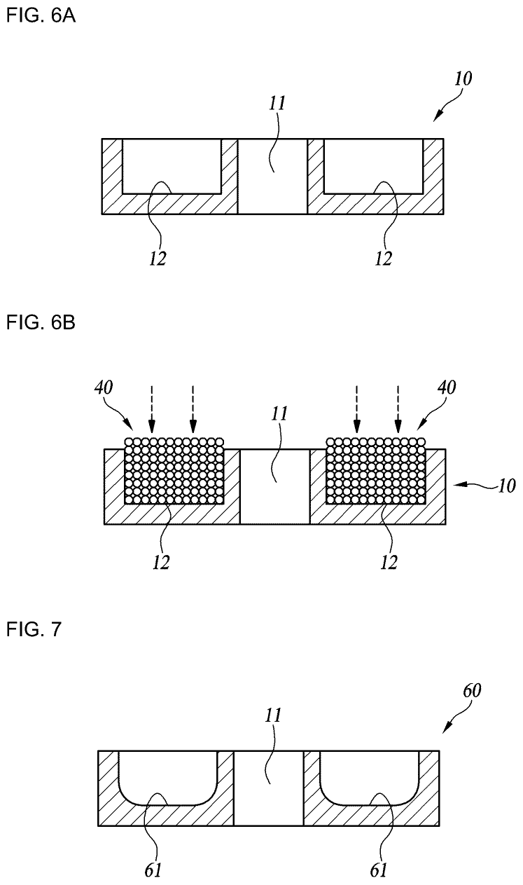

FIG. 6 is a cross-sectional view illustrating a method for manufacturing a magnetic unit according to the present invention. When manufacturing a magnetic unit in the present invention, first, a body (10) and a cover (50) are formed using a conventional method (FIG. 6a). These are formed by casting a magnetizable material such as iron or SCM alloy steel, or by processing a cylindrical base material. At this time, heat treatment is performed on the body (10) and the cover (50) if necessary.

Next, a coil member (40) is formed using a conventional method, and placed in the receiving groove (12) of the body (10) (FIG. 6b). At this time, it is preferable that the coil member (40) be formed with a width equal to that of the receiving groove (12) and a height greater than a certain amount. Next, a press device is used to press the coil member (40) downward for a certain amount of time, thereby forcing the coil member (40) into the receiving groove (12) of the body (10). Accordingly, the conductors forming the coil member (40) are filled with a very high density in the receiving groove (12). Next, an insulating resin, such as an epoxy resin, is applied to the entire upper side of the body (10) and the coil member (40), and a cover (50) is sealed and installed on the upper side. In addition, if necessary, an insulating film (20, 30) is attached to the upper and lower surfaces of the housing (10, 50). The attachment of the insulating film (20, 30) can also be performed immediately after the body (10) and the cover (50) are molded.

According to the field magnet unit (1) according to the above embodiment, the conductors are placed by pressing them into the receiving groove (12) of the body (10), so that the maximum amount of conductors can be placed in the same space. As is known, the strength of the magnetic field generated by the coil member (40) is proportional to the length of the conductor. In addition, when the coil member (40) is pressed into the receiving groove (12), the conductor is placed in the receiving groove (12) while being as close as possible, so that the free space between the body (10) and the conductor is eliminated, thereby preventing the loss of magnetic flux as much as possible. In addition, the above-described field magnet unit can minimize the loss of magnetic flux and improve the efficiency of the field magnet unit by inducing a smooth flow of magnetic flux passing through the entire housing (10, 50) by appropriately setting the material and thickness of the body (10) and the cover (50).

FIG. 7 is a cross-sectional view showing a modified example of the above embodiment. In the embodiments shown in FIGS. 2 to 5, the cross-sectional shape of the receiving groove (12) formed in the body (10) is formed in a square or rectangular shape. In contrast, in the present example, the receiving groove (61) formed in the body (60) is formed in a circular arc shape at the lower corner. This example is designed so that the coil member (40) can be placed more closely in the receiving groove (61) by considering that the cross-section of the conductor constituting the coil member (40) is circular. And the other parts are substantially the same as the above-described embodiment. In addition, in another preferred embodiment of the present invention, the coil member (40) can be configured with a conductor having a square or rectangular cross-section. When forming a coil with a conductor having a circular cross-section, a certain amount of free space exists between the conductors. In contrast, when forming a coil by winding a conductor having a square or rectangular cross-section, the free space between the conductors can be minimized. In addition, since a conductor having a square or rectangular cross-section has a larger surface area than a circular conductor having the same diameter as its width, the overall resistance value of the coil member employing it becomes smaller than that of the coil member using a circular conductor. In other words, it is possible to provide a smoother flow of current. When constructing a field magnet unit using a coil member, the length of the conductor constituting the coil member is set in consideration of the overall resistance value of the coil member. If the length of the conductor increases beyond a certain level, excessive heat is generated from the coil member, and the increase in the temperature of the coil member causes the resistance value of the coil member to increase again, which may cause a short circuit or fire in the coil member. If the overall resistance value of the coil member is lowered, the length of the conductor constituting the coil member can be increased, which provides the effect of enhancing the overall magnetic field strength of the field magnet unit that employs the coil member.

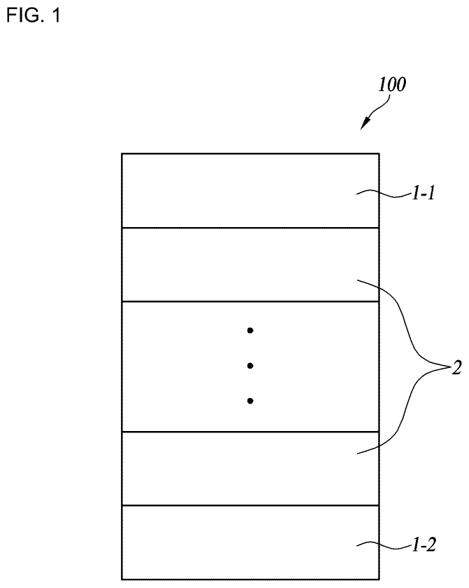

When the field magnet unit (1) according to the present invention is employed in the power conversion device of FIG. 1, direct current or alternating current is applied to the field magnet unit (1), and the armature (2) generates an induced current corresponding to the amount of change in the magnetic field applied from the field magnet unit (1). The power conversion device (100) functions as a DC-DC or AC-AC power conversion device by supplying an appropriate field current to the field magnet unit (1). In the above configuration, the field magnet unit (1) can arrange as many lines as possible in the housing (10, 50). Therefore, the intensity of the magnetic field generated in the field magnet unit (1) can be set to be greater than that of other field magnet units of the same size. In addition, the field magnet unit (1) is mounted while the coil member (40) is in close contact with the housing (10, 50). Accordingly, the magnetic flux loss between the coil member (40) and the housing (10, 50) is minimized. In addition, by appropriately setting the outer wall thickness of the receiving groove (12) of the housing (10, 50) and the thickness of the cover (50), the magnetic flux loss through the outer wall of the field magnet unit (1) is minimized, and the magnetic flux density projected from the field magnet unit (1) to the armature (2) is increased. In addition, preferably, the power conversion device (100) has a core arranged so that it penetrates the entire power conversion device (100) through the hollow portion (11) of the field magnet unit (1). If the permeability of the core is high and the gap between the core and the housing (10, 50) is minimized, the strong magnetic flux generated in the field magnet unit (1) will be linked to the armature (2). The field magnet unit (1) according to the present invention can improve the power conversion efficiency of the power conversion device (100) by efficiently transmitting the magnetic flux generated from the coil member (40) to an external unit, such as the armature (2).

Meanwhile, in the above-described embodiment, it was described that the inner terminal (41b) of the coil member (40) mounted on the housing (10, 50) is pulled downward through the pull-out hole (12a) provided at the bottom of the receiving groove (12). However, the pull-out structure of the outer and inner terminals (41a, 41b) of the coil member (40) is not specified.

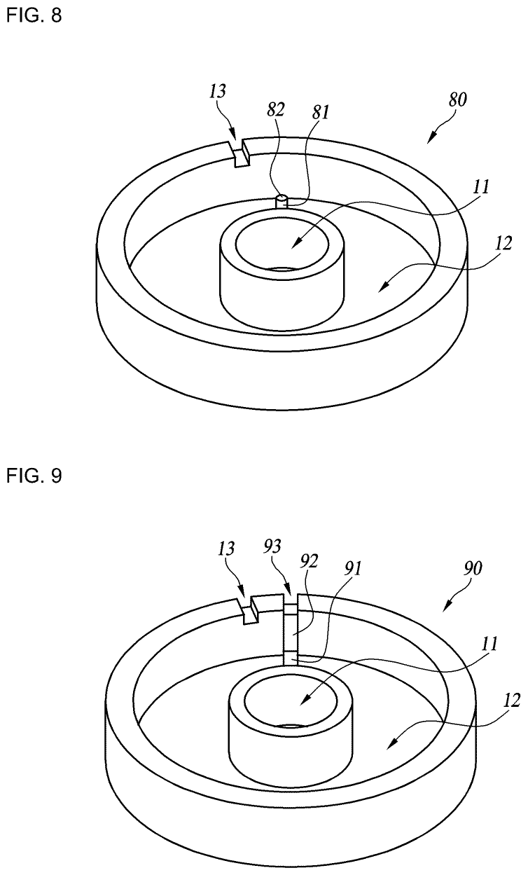

FIG. 8 is a perspective view showing the structure of the body (80) according to the first modified example of the above-described first embodiment. In this example, a pull-out hole (82) for pulling out the inner terminal (41b) of the coil member (40) is provided on the outer wall of the receiving groove (12), and a guide groove (81) is formed on the bottom surface of the receiving groove (12) for guiding the inner terminal (41b) to the pull-out hole (82). In this modified example, the inner terminal (41b) of the coil member (40) is pulled outward through the side of the housing (80, 50) via the guide groove (81) and the extraction hole (82).

FIG. 9 is a perspective view showing the structure of the body (90) according to the second modified example of the first embodiment. In this example, guide grooves (91, 92) are provided on the bottom surface of the receiving groove (12) and the inner surface of the outer wall to guide the inner terminal (41b), and a cut groove (93) is formed on the upper surface of the body (90) to communicate with the guide groove (92) and pull out the inner terminal (41b) to the outside of the housing. In this modified example, the outer and inner terminals (41a, 41b) of the coil member (40) are pulled outward through the upper portion of the body (90).

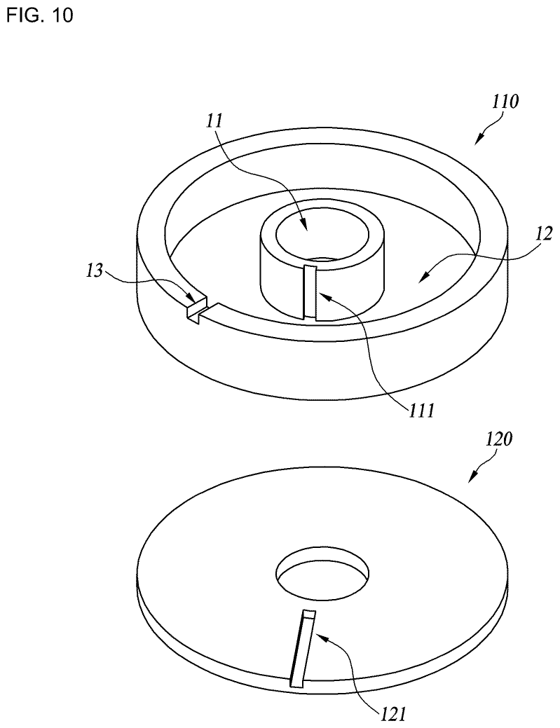

FIG. 10 is a perspective view showing the structure of a body (110) and a cover (120) according to a third modified example of the first embodiment, wherein the cover (120) is a perspective view showing its back configuration. In this example, a guide groove (111) is provided on the inner wall of the storage groove (12) to guide the inner terminal (41b) upward, and a guide groove (121) is formed on the lower surface of the cover (120) to guide the inner terminal (41b) guided upward through the guide groove (111) toward the outside of the housing. In this modified example, like the modified example of FIG. 9, the outer and inner terminals (41a, 41b) of the coil member (40) are pulled outward through the upper portion of the body (110).

In addition, in the embodiment of FIG. 2, after attaching the insulating film (30) to the body (10), the inner terminal (41b) is placed on the outside of the body (10), but this can be configured to place the inner terminal (41b) on the outside of the body (10) and then attach the insulating film (30) to the entire upper surface thereof.

Meanwhile, as described in FIG. 1, the power conversion device (100) exists in various forms such as DC-DC, DC-AC, AC-DC, and AC-AC, and the power conversion device (100) is configured in various forms accordingly. Therefore, the field magnet unit (1) is required to have a configuration that can efficiently cope with various forms of the power conversion device (100).

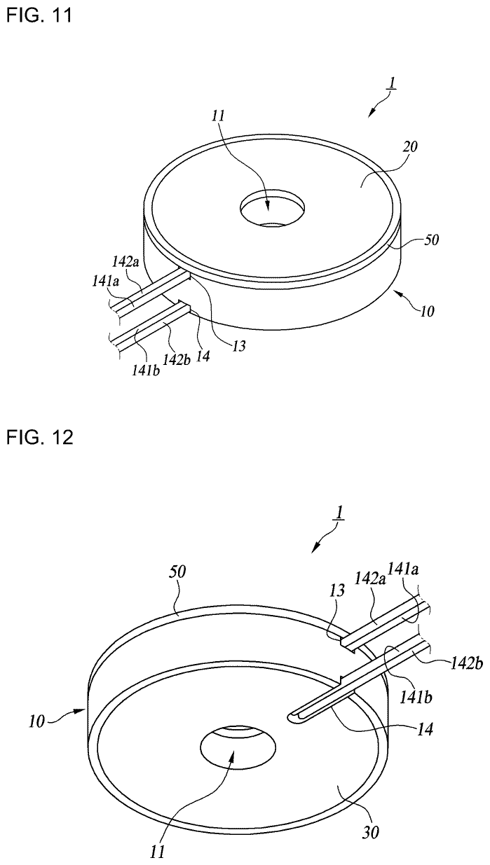

FIG. 11 and FIG. 12 are perspective views of a field magnet unit (1) according to a second embodiment of the present invention, wherein FIG. 11 is a perspective view of the field magnet unit (1) as viewed from above, and FIG. 12 is a perspective view of the field magnet unit (1) as viewed from below. In this embodiment, the field magnet unit (1) has a housing including a body (10) and a cover (50), similar to the above-described embodiment. Meanwhile, in this embodiment, the housing (10, 50) is provided with first and second terminal pairs (141a, 141b) (142a, 142b) for supplying field current, and these are extended to the outside of the housing (10, 50).

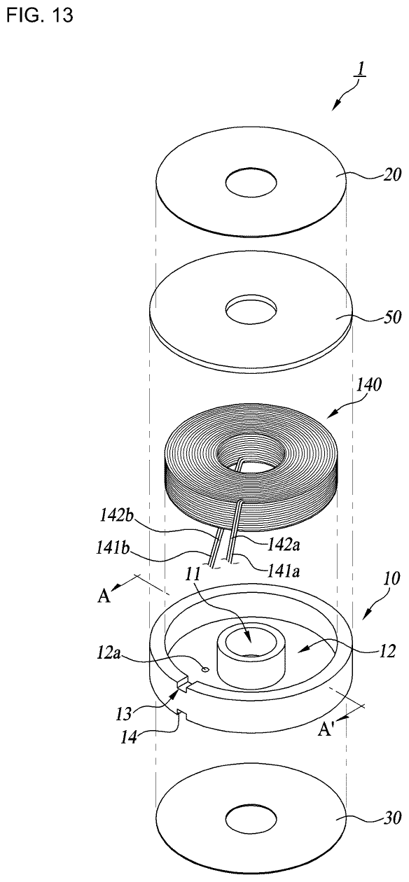

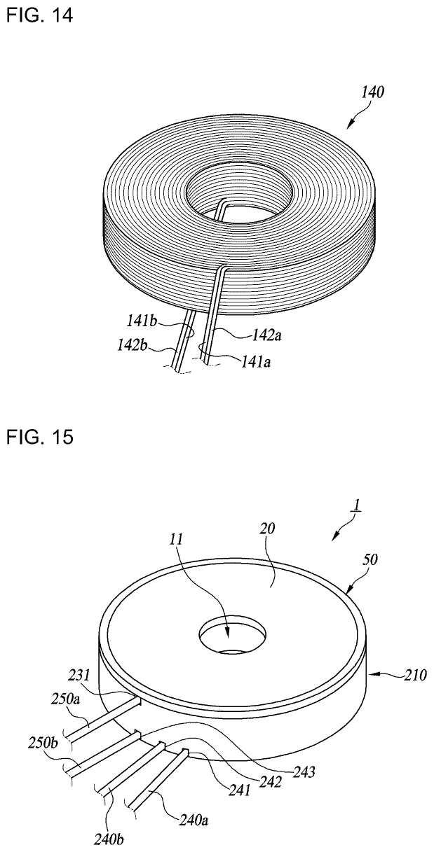

FIG. 13 is an exploded perspective view of the field magnet unit (1) shown in FIGS. 11 and 12, and FIG. 14 is a perspective view showing the external shape of the coil member (140) in FIG. 13. In FIGS. 11 to 14, an annular receiving groove (12) is provided on the upper surface of the body (10) with a hollow portion (11) as the center, and a coil member (140) is installed in the receiving groove (12). In the present embodiment, the coil member (140) is configured such that first and second conductors coated with an insulating material such as enamel are simultaneously wound together. In addition, in the present embodiment, an insulating film may be coated on the outer side of the coil member (140) to completely wrap the coil member (140) for more reliable insulation between the coil member (140) and the housing (10, 50).

The coil member (140) is provided with first and second terminal pairs (141a, 141b) and (142a, 142b). In the terminal pairs, one terminal (141a, 142a) is arranged on the upper outer periphery of the coil member (140) to form an outer terminal of the coil member (140), and the other terminal (141b, 142b) is arranged on the lower inner periphery of the coil member (140) to form an inner terminal. Here, the outer terminals (141a, 142a) are drawn out to the outside of the housing (10, 50) through a cut-out groove (13) formed on the upper surface of the body (10), and the inner terminals (141b, 142b) are drawn out to the outside of the housing (10, 50) through a drawing hole (12a) formed on the lower portion of the receiving groove (12). And the remaining parts are substantially the same as the first embodiment described above.

When the field magnet unit (1) according to the present invention is employed in the power conversion device (100) of FIG. 1, field current is supplied to the first and second conductors, i.e., the first and second terminal pairs (141a, 141b) (142a, 142b), respectively. The supply of the field current can be performed in various ways. For example, direct current or alternating current can be supplied to the first and second terminal pairs (141a, 141b) and (142a, 142b). In addition, separate field currents can be supplied to the first and second terminal pairs (141a, 141b) and (142a, 142b), respectively, and the first and second terminal pairs (141a, 141b) (142a, 142b) can be connected in series or in parallel for a single field current. When the first and second terminal pairs (141a, 141b) and (142a, 142b) are connected in parallel, the overall resistance value of the coil member (140) will be significantly reduced.

In addition, when a DC field current is supplied to the first and second terminal pairs (141a, 141b) and (142a, 142b), a field current in the opposite direction can be supplied to the first and second terminal pairs (141a, 141b) and (142a, 142b). This application can be preferably employed in a DC-AC power conversion device. In the power conversion device (100) of FIG. 1, when a general field magnet unit is employed to configure a DC-AC power conversion device, a plurality of field magnet units are usually required. This complicates the configuration of the power conversion device. In addition, when configuring a DC-AC power conversion device using a single field magnet unit, a configuration is required to convert the field current supplied to the field magnet unit into AC. This complicates the driving circuit of the power conversion device and increases the demand for expensive components for current interruption, such as an IGBT (Insulated Gate Bipolar Transistor). The field magnet unit (1) according to the present invention can configure a DC-AC power conversion device through a simple configuration that alternately supplies DC in opposite directions through the first and second terminal pairs (141a, 141b) (142a, 142b).

In addition, in this embodiment, the lead-out structure of the first and second terminal pairs (141a, 141b) (142a, 142b) for the coil member (140) is not specified. In this embodiment, the housing structure shown in FIGS. 8 to 10 can be adopted in the same manner. Additionally, in the present embodiment, the coil member (140) may be composed of a conductor having a square or rectangular cross-section.

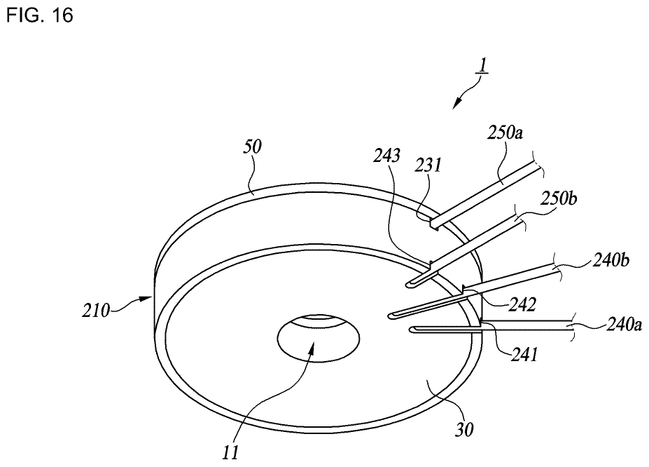

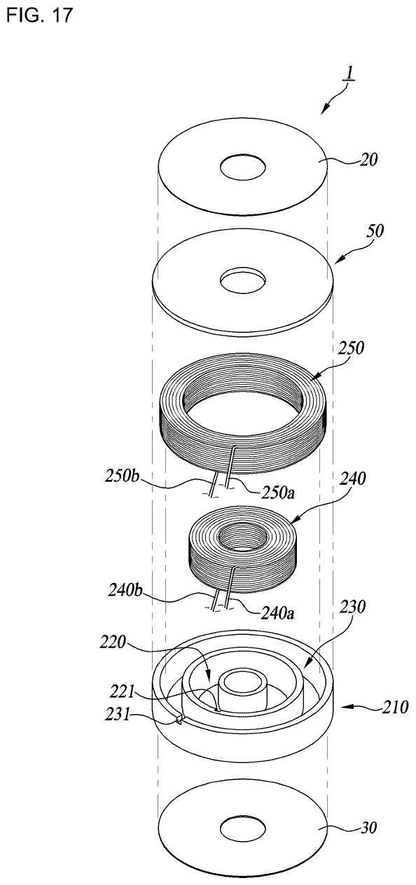

FIG. 15 is a perspective view of the field magnet unit (1) according to the third embodiment of the present invention viewed from above, and FIG. 16 is a perspective view of the field magnet unit (1) viewed from below. In addition, FIG. 17 is an exploded perspective view of the field magnet unit (1) shown in FIG. 15. In the drawing, the field magnet unit (1) has a body (210) and a cover (50). The body (210) and the cover (50) constitute the housing of the field magnet unit (1). The housing, i.e., the body (210) and the cover (50), is made of a material that can be magnetized.

First and second coil members (240, 250) are mounted inside the body (210). The coil members (240, 250) are made of a structure in which a conductor coated with an insulating material such as enamel is wound, as is the case with conventional ones. The first and second coil members (240, 250) are provided with terminal pairs (240a, 240b) (250a, 250b) for supplying the field current, respectively, and these are extended to the outside of the housing (210, 50).

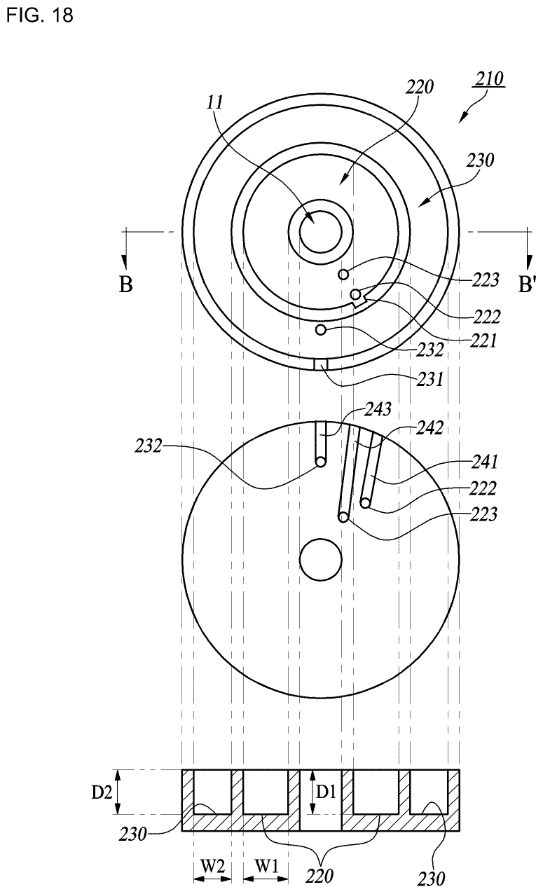

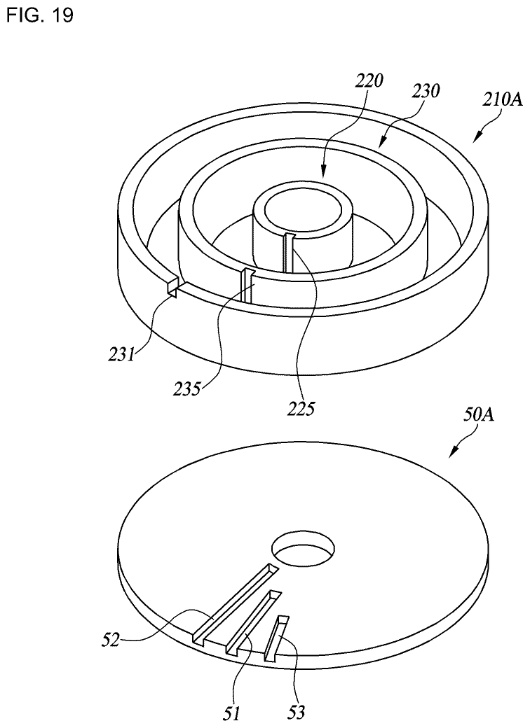

FIG. 18 is a plan view, a back view, and a cross-sectional view along the line B-B′ of the body (210) constituting the housing in FIG. 17. An annular first receiving groove (220) is provided on the upper part of the body (210) with a hollow portion (11) as the center, and an annular second receiving groove (230) is provided on the outside of the first receiving groove (220) at a certain interval from the first receiving groove (220). The size and shape of the first and second receiving grooves (220, 230) are not specified. In a preferred embodiment, the first and second receiving grooves (220, 230) are set in size, i.e., width and depth, so that their volumes are approximately the same. First and second coil members (240, 250) are installed in the first and second receiving grooves (220, 230), respectively. In a preferred application example of the field magnet unit (1), the first coil member (240) and the second coil member (250) are driven to generate first and second magnetic fluxes, respectively. And at this time, the first and second magnetic fluxes need to be set to have the same size. When the field current values supplied to the first and second coil members (240, 250) are the same, the size of the magnetic flux generated in the coil members (240, 250) is determined by the length of each conductor. Accordingly, the cross-sectional area of the second coil member (250) becomes smaller than the cross-sectional area of the first coil member (240). Preferably, the size of the storage grooves (220, 230) is set to an appropriate size considering the size of the coil members (240, 250). Preferably, the coil members (240, 250) are press-fitted into the storage grooves (220, 230), respectively. When the width of the first storage groove (220) is W1, the depth is D1, and the width of the second storage groove (230) is W2, the depth is D2, the width (W1) or the depth (D1) of the first storage groove (220) will be set to be larger than the width (W2) or the depth (D2) of the second storage groove (230).

In FIGS. 15 to 18, a first receiving groove (220) of a body (210) has a lower portion formed with an extraction hole (222, 223) for extracting a pair of terminals (240a, 240b) of a first coil member (240) to the outside of the housing, respectively. In addition, a guide groove (221) is provided on the inner surface of an outer wall forming the first receiving groove (220) for guiding the outer terminal (240a) of the first coil member (240) to the lower extraction hole (222). In addition, a cut groove (231) is provided on the upper surface of the outer wall forming the second storage groove (230) to connect the outer side of the body (210) and the second storage groove (230) while allowing the outer terminal (250a) of the second coil member (250) to be drawn out to the outside of the housing, and an extraction hole (232) is provided on the lower portion of the second storage groove (230) to allow the inner terminal (250b) of the second coil member (250) to be drawn out to the outside of the housing. And, on the lower surface of the body (210), guide grooves (241 to 243) are formed toward the outer periphery while communicating with the above-mentioned extraction holes (222, 223, 232), respectively. These guide grooves (241 to 243) are for guiding the terminals (240a, 240b, 250b) extracted through the extraction holes (222, 223, 232) toward the outer surface of the housing. The guide grooves (241 to 243) are designed to place the field magnet unit (1) in close contact with another device or unit, and may be omitted as needed.

When the field magnet unit (1) according to the present embodiment is employed in the power conversion device (100) of FIG. 1, field current is supplied to each of the first and second coil members (240, 250). The supply of the field current can be performed in various ways. For example, the first and second coil members (240, 250) may be supplied with direct current or alternating current. In addition, the first and second coil members (240, 250) may be supplied with separate field currents, and the first and second coil members (240, 250) may be connected in series or in parallel for a single field current. When the first and second coil members (240, 250) are connected in parallel, the overall resistance value of the coil members (240, 250) will be significantly reduced.

In addition, when supplying a DC field current to the first and second coil members (240, 250), a field current in a mutually opposite direction may be supplied to each of the first and second coil members (240, 250). Of course, in this case, while the field current in the same direction is supplied to the first and second coil members (240, 250), the first and second coil members (240, 250) may have the conductors wound in a mutually opposite direction. This application may be preferably employed in a DC-AC power conversion device. The field magnet unit (1) according to the present embodiment may configure various types of power conversion devices by changing the method of supplying the field current to the first and second coil members (30, 40).

In addition, FIG. 19 is a perspective view showing the structure of a body (210A) and a cover (50A) according to another modified example of the third embodiment described above, wherein the cover (50A) shows its back configuration. In this example, a guide groove (225) is provided on the inner wall of the first receiving groove (220) to guide the inner terminal (240b) of the first coil member (240) upward, and a guide groove (235) is provided on the inner wall of the second receiving groove (230) to guide the inner terminal (250b) of the second coil member (250) upward. And, on the lower surface of the cover (50A), a guide groove (51, 52) is formed to guide the outer terminal (240a) of the first coil member (240) and the inner terminal (240b) of the first coil member (240) guided upward through the guide groove (225) toward the outer side of the housing, and a guide groove (53) is formed to guide the inner terminal (250b) of the second coil member (250) guided upward through the guide groove (235) toward the outer side of the housing. In this modified example, the terminal pairs (240a, 240b) and (250a, 250b) of the first and second coil members (240, 250) are pulled outward through the upper portion of the body (210).

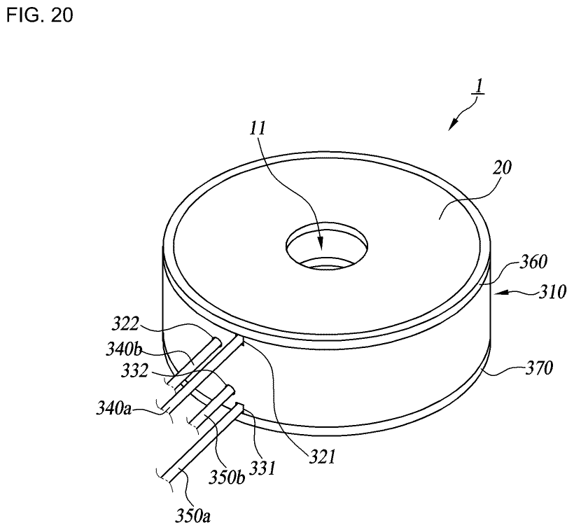

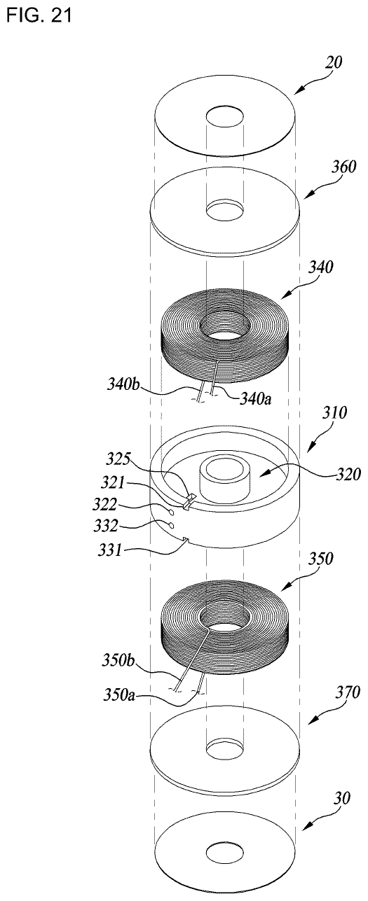

FIG. 20 is a perspective view of a field magnet unit (1) according to a fourth embodiment of the present invention, and FIG. 21 is an exploded perspective view of the field magnet unit (1) shown in FIG. 20. In the drawing, the field magnet unit (1) has a cylindrical body (310), and covers (360, 370) are installed on the upper and lower sides of the body (310), respectively. The body (310) and the covers (360, 370) constitute a housing of the field magnet unit (1). The housings (310, 360, 370) are made of a material that can be magnetized. First and second coil members (340, 350) are mounted inside the body (310). More specifically, the first coil member (340) is mounted on one side of the body (310), that is, on the upper side of the body (310) in the drawing, and the second coil member (350) is mounted on the other side of the body (310), that is, on the lower side of the body (310) in the drawing. The coil members (340, 350) are configured, as in a conventional one, with a conductor coated with an insulating material such as enamel wound around them. The first and second coil members (340, 350) are provided with terminal pairs (340a, 340b) (350a, 350b) for supplying field current, respectively, and these are extended outside the housing (310, 360, 370).

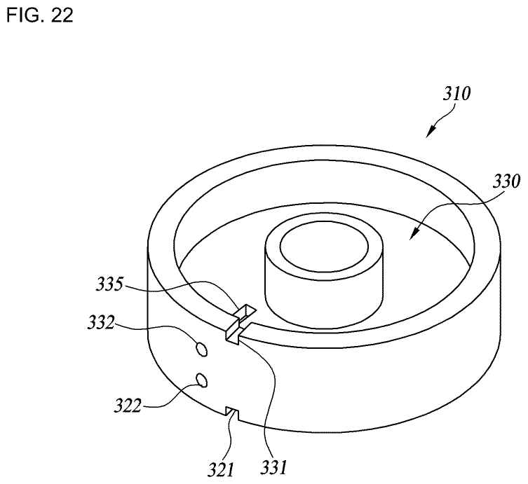

FIG. 22 is a perspective view of the body (310) as viewed from below in FIG. 21. In FIGS. 21 and 22, the body (310) is configured as a cylindrical shape with a hollow central portion. A first storage groove (320) is provided in an annular shape centered around a hollow portion (11) on the upper portion of the body (310), and correspondingly, a second storage groove (330) is provided in an annular shape centered around the hollow portion (11) on the lower portion of the body (310). Preferably, the first storage groove (320) and the second storage groove (330) are formed in the same shape and size. Of course, the size and shape of each of the first and second storage grooves (320, 330) are not specified. First and second coil members (340, 350) are installed in the first and second storage grooves (320, 330), respectively. The size of the storage grooves (320, 330) is set to an appropriate size considering the size of the coil members (340, 350). Preferably, the coil members (340, 350) are press-fitted into the storage grooves (320, 330), respectively.

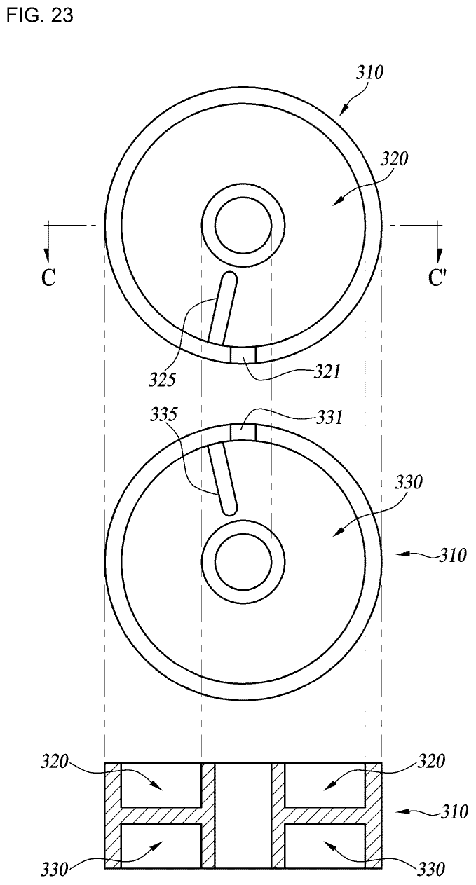

FIG. 23 is a plan view, a back view, and a cross-sectional view along line C-C′ of the body (310) constituting the housing in FIG. 21. As described above, the first and second coil members (340, 350) are provided with terminal pairs (340a, 340b) (350a, 350b), respectively. The upper and lower surfaces of the body (310), more specifically, the upper surfaces of the respective outer walls constituting the first and second receiving grooves (320, 330), are provided with cut grooves (321, 331), respectively, so as to connect the outer side of the body (310) with the receiving grooves (320, 330). These cut grooves (321, 331) are for drawing out the outer terminals (340a, 350a) of the coil members (340, 350) to the outer side of the housing, respectively. In addition, on each outer wall of the receiving grooves (320, 330), a drawing hole (322, 332) is provided to draw out the inner terminal (340b, 350b) of the coil member (340, 350) to the outside, and on the bottom surface of the receiving grooves (320, 330), a guide groove (325, 335) is formed toward the circumferential surface while communicating with the drawing hole (322, 332). The inner terminal (340b, 350b) of the coil member (340, 350) is guided toward the circumferential surface through the guide grooves (325, 335), respectively, and then drawn out of the body (310) through the drawing hole (322, 332).

In this embodiment, similarly to the third embodiment described above, first and second coil members (340, 350) are provided inside the housing (310, 360, 370). And, field current is supplied to the first and second coil members (340, 350), respectively. The driving method of the first and second coil members (340, 350) or the supply of field current to them can be performed in the same manner as in the third embodiment.

In addition, in the present embodiment, the method of withdrawing the terminal pair (340a, 340b) (350a, 350b) of the first and second coil members (340, 350) to the outside of the housing (310, 360, 370) is not specified. In the present embodiment, the withdrawing structure for the terminal pair (340a, 340b) (350a, 350b) can apply the embodiments shown in FIGS. 9 and 10.

### INDUSTRIAL APPLICABILITY

The present invention can be applied to a power conversion device configured by stacking a field magnet unit and an electric unit. In addition, the electric unit according to the present invention can be used as an actuator for operating various valves, a lifter for lifting a heavy object including iron, an electromagnet for a clutch or brake device for a power transmission device, etc.

1. A field magnet unit for a power conversion device configured by stacking a field magnet unit and an armature in a mutually opposing manner, wherein the field magnet unit generates a magnetic field toward the armature according to a current applied from the outside, the field magnet unit comprising:
a cylindrical housing having a hollow portion in the central portion, and
a coil member installed on the inside of the housing, and
wherein the housing comprises a body made of a magnetizable material, having a hollow central portion, and having a receiving groove on the upper portion for mounting the coil member, and a cover installed on the upper portion of the body, having a hollow central portion, and being made of a magnetizable material,
and the coil member comprises first and second terminals for supplying current to the conductive line, and is characterized in that the coil member is configured such that a conductive line is wound around it.

2. The field magnet unit for a power conversion device according to claim 1, wherein the coil member is installed by being pressed into the receiving groove.

3. The field magnet unit for a power conversion device according to claim 1, wherein the cover and the body are coupled with an insulating resin.

4. The field magnet unit for a power conversion device according to claim 1, wherein the housing is composed of SCM alloy steel.

5. The field magnet unit for a power conversion device according to claim 1, wherein the housing is heat treated.

6. The field magnet unit for a power conversion device according to claim 1, wherein the lower edge portion of the storage groove has an arc shape.

7. The field magnet unit for a power conversion device according to claim 1, wherein the outer wall of the storage groove has a thickness of 3 mm or more.

8. The field magnet unit for a power conversion device according to claim 1, wherein the cover has a thickness of 10 mm or less.

9. The field magnet unit for a power conversion device according to claim 1, wherein a first cutting groove is provided on the upper surface of the storage groove for withdrawing the first terminal outward.

10. The field magnet unit for a power conversion device according to claim 1, wherein a drawing hole for drawing a second terminal outward is provided on the lower or outer wall of the storage groove.

11. The field magnet unit for a power conversion device according to claim 10, wherein a first guide groove is provided on the bottom surface of the storage groove while communicating with the extraction hole.

12. The field magnet unit for a power conversion device according to claim 10, wherein a second guide groove is provided on the lower surface of the housing and communicates with the extraction hole.

13. The field magnet unit for a power conversion device according to claim 1, wherein a second cut groove is provided on the upper surface of the storage groove for withdrawing the second terminal outward, and a third guide groove is provided on the lower surface and the outer wall of the storage groove while communicating with the second cut groove.

14. The field magnet unit for a power conversion device according to claim 1, wherein a fourth guide groove is provided on the inner wall of the storage groove for guiding the second terminal upward, and a fifth guide groove is provided on the lower surface of the cover for guiding the second terminal guided upward by the fourth guide groove toward the outside of the housing.

15. The field magnet unit for a power conversion device according to claim 1, wherein an insulating film is additionally provided on the upper or lower surface of the housing.

16. The field magnet unit for a power conversion device according to claim 1, wherein the conductor constituting the coil member has a square or rectangular cross-section.

17-36. (canceled)
